(19) United States
(12) Patent Application Publication
(10) Pub. No.: US 2011/0131055 A1
(43) Pub. Date: Jun. 2, 2011

(54) PATIENT-BASED IMMUNIZATION TRACKING

(76) Inventors: Ken GRADY, Carlisle, MA (US); Giuia Abano Grady, Carlisle, MA (US)

(21) Appl. No.: 12/627,846

(22) Filed: Nov. 30, 2009

(51) Int. Cl. G06Q 10/00; G06Q 50/00

(52) U.S. Cl. 705/2

(57) ABSTRACT

Techniques for patient management of immunizations, including performing steps of recording patient information including a date of birth; recording information for immunization doses received by the patient, including the date each dose was received; obtaining an immunization schedule from a remote computer system; generating a plurality of recommended immunization doses based on the recorded immunization doses received by the patient and the date of birth of the patient, each recommended immunization dose having a recommended time period for administration of the dose; recording a selected date of administration for a recommended immunization dose; displaying a list of the recommended immunization doses, along with their respective date of administration or recommended time period for administration.

### TECHNICAL FIELD

This application relates to techniques and equipment that enable patients to track and manage immunizations.

### BACKGROUND

In most states, it is the responsibility of the parents of school-aged children, not family doctors, to provide vaccination records to a state health department and to schools. In most states, children are not allowed to enter school or childcare unless they can prove that they meet all school or childcare immunization requirements. Also, in certain circumstances, if a patient cannot locate a record of immunization, it may be necessary to repeat some of the immunizations or arrange blood tests to determine immunity. Thus, it can be important to maintain an accurate immunization record.

Immunizations include, but are not limited to, Hepatitis A, Hepatitis B, Rotavirus, Diphtheria, Tetanus, Pertussis, Haemophilus influenzae type b, Pneumococcal (polysaccharide), Inactivated Poliovirus, Influenza, Measles, Mumps, Rubella, Varicella, Meningococcal, Human Papillomavirus HPV), and Zoster. For simplicity, the term “patient” may refer to a patient or a caregiver for a patient; for example, a parent of a child or a relative of an elderly patient.

However, it conventionally has been difficult to maintain an accurate record of received immunizations. Patients often track received immunizations by either keeping paperwork received when immunizations are administered, or relying on a doctor or clinic to maintain records of received immunizations. However, immunization records are maintained by medical providers for a limited number of years, and then usually only by the medical provider who actually administered the vaccines. Today patients move, travel, and change health providers more than in previous generations. By two years of age, over 20% of the children in the U.S. typically have seen more than one healthcare provider, resulting in scattered paper medical records. Sometimes schools hold the vaccination records of children who attended, but these records are generally not kept for more than a year or two or, at the longest, until graduation. After a student graduates, records are sent to storage and may not be accessible.

Recently, centralized immunization registries have been implemented. However, many patients received immunizations prior to the institution of these registries. Also, no universal registry system exists. Registries in one state or area may not be compatible with other registries, and information may have to be manually transferred from registry to registry. As far as patient management of immunization records, there have been limited attempts at replacing the “shoe box” approach of keeping original paper records with electronic recordkeeping.

Additionally, patients are generally underinformed as to what immunizations are recommended, or on what schedule they should be received. Although certain events, such as the recent “H1N1” flu virus, may direct attention to specific immunization efforts, few patients are aware of or understand the spectrum of recommended immunizations. Instead, patients have relied, often unwittingly, upon medical providers to ensure adherence with recommended immunization schedules. However, where, as discussed above, medical providers have difficulty in identifying the immunizations a patient has already received, this task is not simple.

Also, even when a medical provider is successfully ensuring a patient adheres to recommended immunization schedules, such as those released by the Centers for Disease Control and Prevention (CDC), generally patients are unaware of upcoming immunizations. This can lead to surprise when a patient shows up for a visit, and in some cases reluctance to receive an unexpected immunization.

Hence, a need exists to enable patients to more accurately track received immunizations, plan for upcoming immunizations, and become better educated as to recommended immunizations, to better maintain the health and well-being of families and loved ones.

### SUMMARY

The teachings herein alleviate one or more of the above noted issues with tracking and managing immunizations. The method includes performing steps of recording patient information including a date of birth; recording information for immunization doses received by the patient, including the date each dose was received; obtaining an immunization schedule from a remote computer system; generating a plurality of recommended immunization doses based on the recorded immunization doses received by the patient and the date of birth of the patient, each recommended immunization dose having a recommended time period for administration of the dose; recording a selected date of administration for a recommended immunization dose; displaying a list of the recommended immunization doses, along with their respective date of administration or recommended time period for administration.

In one example, these steps are performed by a computer programmed to perform the above steps. In another example, a mobile device is programmed to perform the above steps. In another example, an article of manufacture includes programming instructions for causing a processor to perform the above steps and a machine readable storage medium bearing the programming instructions.

The methods as outlined above may be implemented as various combinations of hardware and software. System hardware may comprise special purpose hardware or one or more general purpose devices server devices programmed to implement the social network related functions. There may also be some programming of mobile devices to support the disclosed methodologies. A software product includes at least one machine-readable medium and information carried by the medium. The information carried by the medium may be executable program code for causing a programmable device to implement the disclosed functions

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates a screen providing an interface for listing and managing patients tracked by an application embodying the disclosed subject matter.

FIG. 2 illustrates a screen providing an interface provided by an embodiment of the disclosed subject matter for the entry and review of patient information.

FIG. 3 illustrates a display settings screen for an embodiment of the disclosed subject matter, providing an interface for controlling information provided by a planner interface illustrated in FIGS. 4-5B.

FIGS. 4A-4C illustrate operation of a planner interface for embodiments of the disclosed subject matter. FIG. 4A illustrates an example where a received dose filter setting has been enabled. FIGS. 4B and 4C illustrate examples in which upcoming immunizations are listed.

FIGS. 5A and 5B illustrate immunization dose interface for an embodiment of the disclosed subject matter.

FIGS. 6A and 6B illustrate immunization information interfaces for embodiments of the disclosed subject matter. FIG. 6A illustrates the display of textual information. FIG. 6B illustrates providing video information.

FIG. 7 illustrates an interface for an embodiment of the disclosed subject matter, for finding and displaying regional immunization providers.

FIG. 8 illustrates a networked system embodying the disclosed invention.

FIG. 9 illustrates a programmable computer system for some embodiments of the disclosed subject matter.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The disclosure relates to techniques that enable patients to more accurately track received immunizations, plan for upcoming immunizations, and become better educated as to recommended immunizations. Armed with such information, patients are better prepared to work as active participants in maintaining the health and well-being of families and loved ones through proper immunization practices.

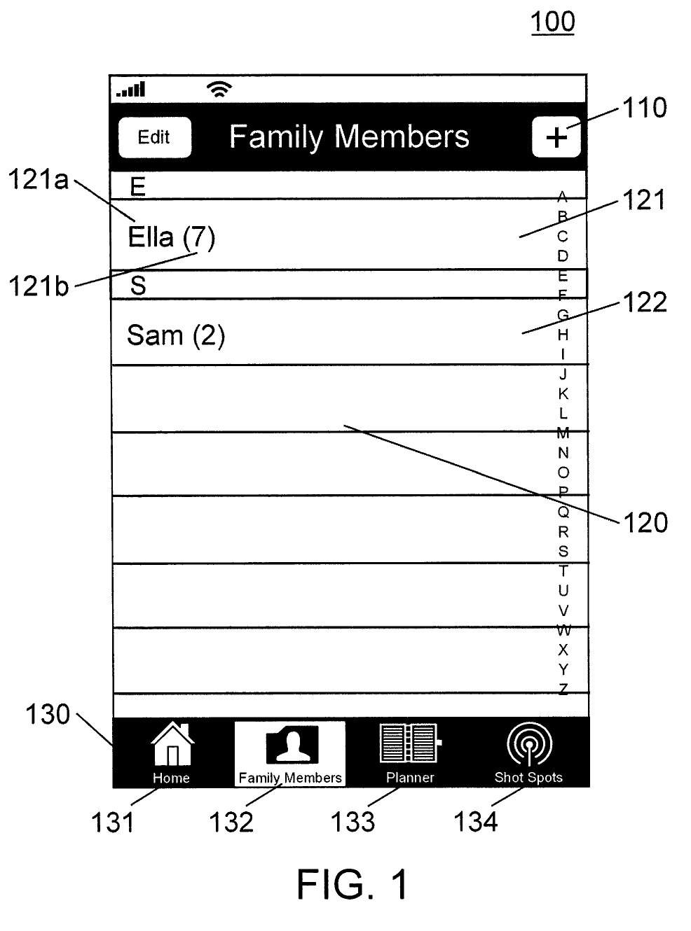

FIGS. 1-8 illustrate aspects of the disclosed invention as embodied as an application on an Apple iPhone smart phone device. These figures are simply provided to discuss, by way of illustration, operation of embodiments of the disclosed invention. However, practice of the invention is not limited by the figures provided by this application.

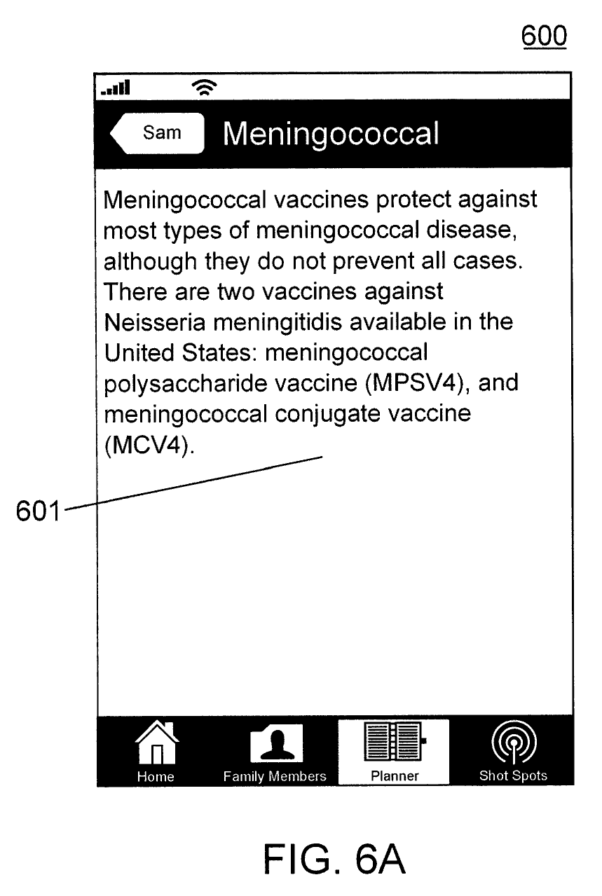

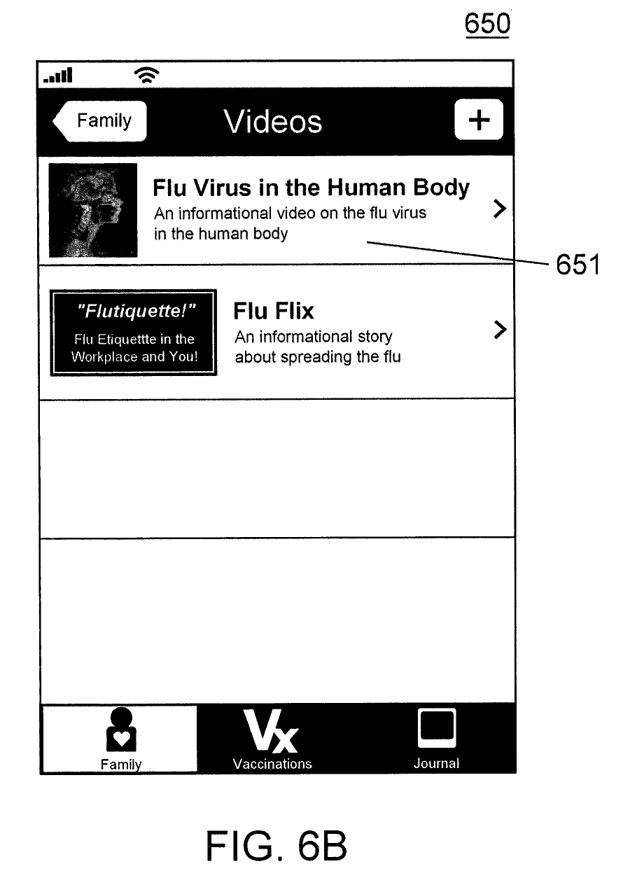

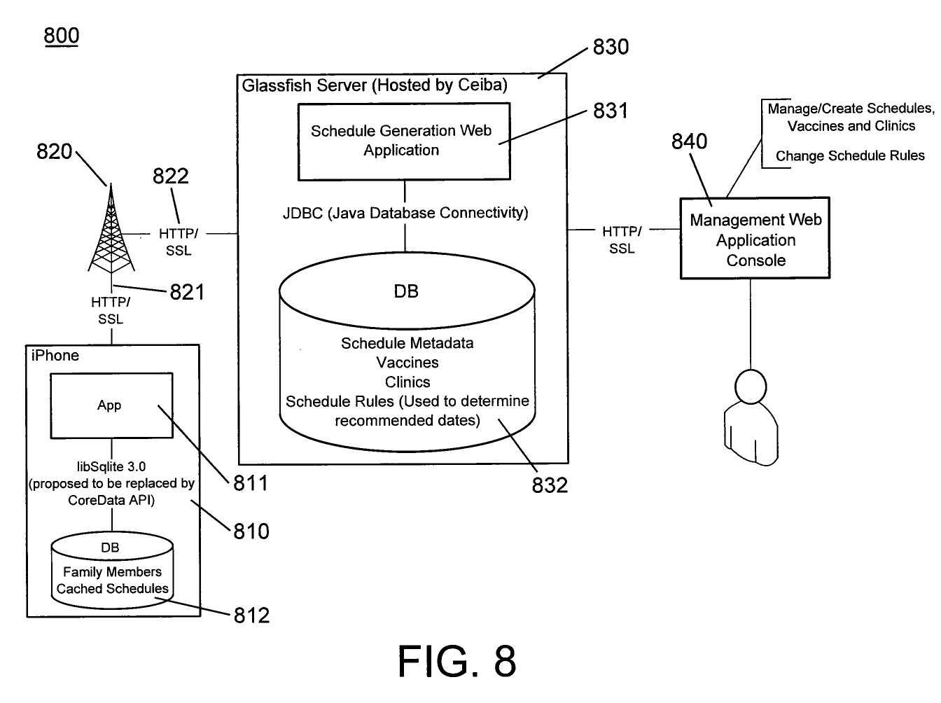

FIG. 8 illustrates a networked system embodying the disclosed invention. Application 811 executes on mobile device 810, and stores data, such as patient information and cached immunization schedule information, in database 812. Database 812 is stored in non-volatile memory included in mobile device 810. Examples of mobile devices are hand-held devices with wireless phone/network capability and the capability to execute software applications, such a the iPhone or iPod Touch by Apple, devices running the Google Android operating system, Blackberry by RIM, devices running the Microsoft Windows Mobile operating system, PDAs, notebook computers, and personal computers. This list is only illustrative. Other information, whether received by a user of application 811 or received via communication network 820, may be stored by application 811 in database 812. Application 811 on mobile device 810 communicates with remote computer system 830 via communication network 820. In some embodiments, link 821 between mobile device 810 and communication network 820 is a wireless networking link, and link 822 between remote computer system 830 and communication network 820 includes the Internet. Web application 831 executes on remote computer system 830, and is responsive to requests and commands from application 811. In some embodiments, HTTP over SSL is employed for communication between application 811 and web application 831 to provide a secure channel of communication. Web application 831 stores data, such a immunization schedule metadata, immunization information (such as the information illustrated in FIGS. 6A and 6B), immunization provider information (for use in locating and/or mapping regional immunization providers, as discussed above), and immunization schedule rules (which are used by application 811 to determine recommended dates for receiving immunization doses), in database 832. Additionally, management console 840 connects to remote computer system 830 in order to manage and create data in database 832 regarding, for example, immunization schedules, immunization information, immunization provider information, and immunization schedule rules. One source for recommended immunization schedules are the various immunization schedules for children, adolescents, and adults released by the CDC and the Advisory Committee on Immunization Practices (AICP).

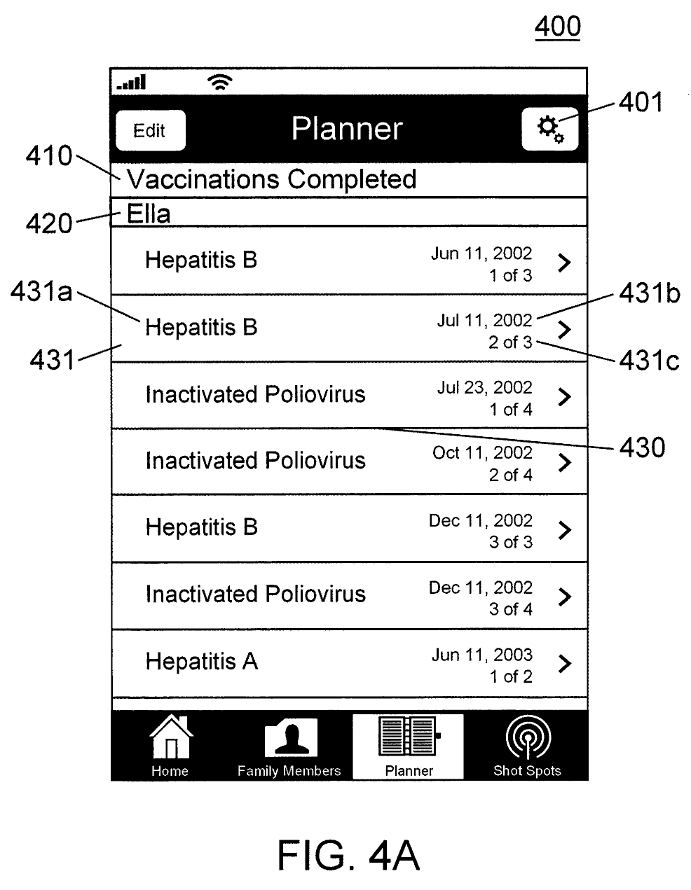

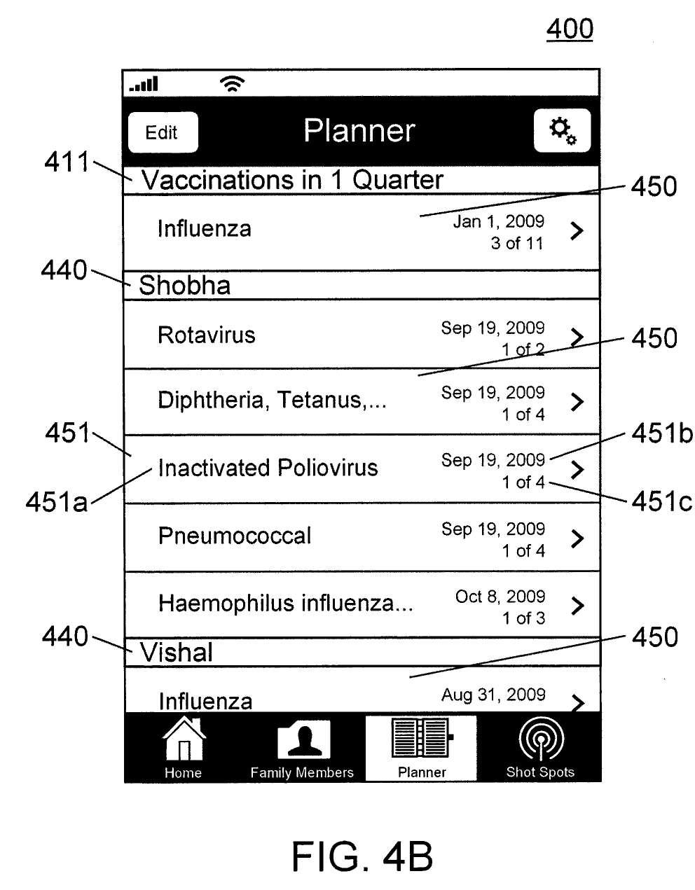

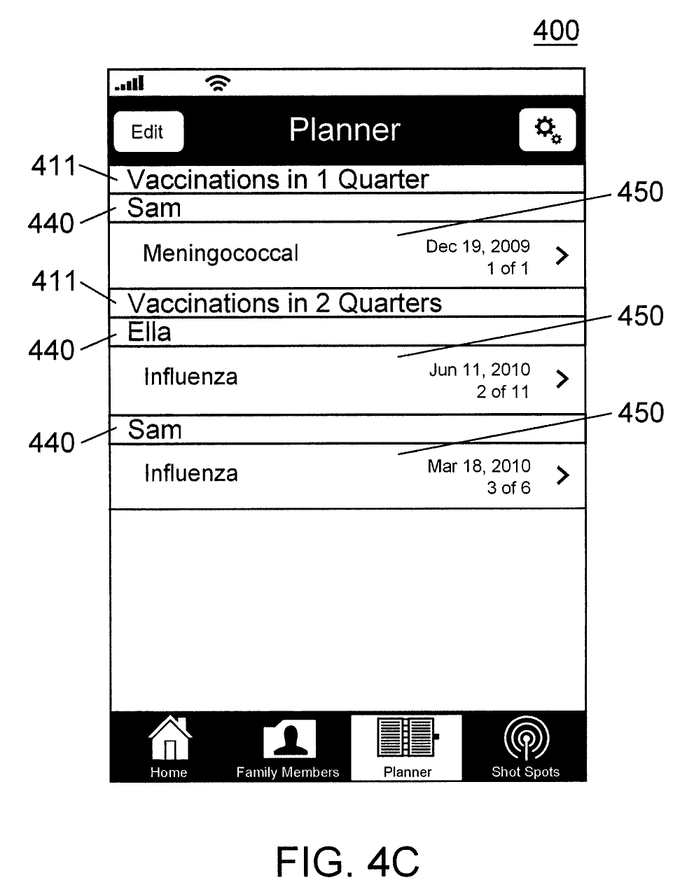

The immunization schedule metadata and rules provide information for individual immunizations which may be managed using application 811, and include for each immunization, for example, a unique identifier (for use in storing and retrieving data related to the immunization, whether on mobile device 810 or remote computer system 830), a brief text name (e.g., “Hepatitis B” or “Inactivated Poliovirus”, as illustrated in FIG. 4A), recipient age information (e.g., recommended age for first dose, recommended age range for receipt of immunization), number of recommended doses, recommended schedule for receipt of doses (e.g., ranges of time between subsequent doses, which may differ from dose to dose), “catch-up” schedule information (for identifying when a patient is behind a standard recommended schedule for the immunization, and providing an accelerated schedule for catching up). Based on this immunization schedule information, the birth date of a patient, and recorded information about immunization doses previously received by the patient, application 811 generates a schedule of recommended immunization doses for the patient. Each recommended dose corresponds to a particular immunization, and a recommended range of dates of administration is generated for each dose. For example, where an adult (as determined by the patient's birth date) patient has received a first of three recommended doses on Apr. 13, 2009, application 811 would generate two recommended doses of Hepatitis B vaccine: the first during May 13, 2009 to Jun. 13, 2009, and the second from Aug. 13, 2009 to Oct. 13, 2009 (in accordance with the AICP recommended schedule of adult vaccinations for October 2007 to September 2008). Upon later recordation of the receipt of the second of three doses of the Hepatitis B vaccine, application may revise the recommended schedule for the final dose.

In one embodiment, mobile device 810 transmits a patient's date of birth to remote computer system 830. Based on the date of birth, remote computer system 830 selects an appropriate recommended immunization schedule (e.g., child, adolescent, or adult), calculates recommended time periods for administration of immunization doses, and transmits the calculated recommended immunization schedule to mobile device 810. Mobile device 810 uses this immunization schedule calculated by remote computer system 830. For a new patient, mobile device 810 may provide an option to automatically generate and record administration dates for immunization doses that should have been received in view of the current date and the recommended administration dates provided by remote computer system 830. Alternatively, the user may be requested, or simply allowed, to provide/update this information with actual dates on which particular doses were received. Additionally, application 811 may revise the schedule received from remote computer system 830 to shift recommended immunization dates in view of recorded immunization dosage dates. For example, application 811 may move upcoming dosage dates to a later time in order to maintain a 2-month period of time between subsequent doses.

As distributed for installation on mobile devices, application 811 may include an initial set of schedule metadata and rules (allowing a user to immediately make use of application 811 without initially obtaining information from remote computer system 830. However, it is preferred that application 811 initially obtains such information from remote computer system 830, in order to ensure that the user is operating with the most current information regarding available immunizations and their scheduling information. Additionally, application 811 regularly checks with remote computer system 830 for updates in immunization information. Such update checks might occur each time application 811 is started and/or they may be performed at a regular time interval (e.g., on a daily, weekly, or monthly basis). In some embodiments, when new immunization information is received that affects a patient managed by application 811 (e.g., a new immunization, or a change in immunization schedule metadata or rules that conflicts with a selected date for immunization), application 811 notifies the user that updated information relevant to one or more patients managed by application 811 has been received.

In a preferred embodiment, application 811 only stores patient-related information in database 812 of mobile device 810, and does not transmit such information via communication network 820 or store such information in remote computer system 830. By operating in this manner, application 811 maintains the privacy and confidentiality of patient records. This may be helpful in ensuring and demonstrating compliance with privacy regulations for medical records, such as HIPAA. In some embodiments, patient information may be stored outside of mobile device 810. For example, mobile device may be attached to a personal computer (PC) in order to back up and restore data maintained by application 811. However, a patient's date of birth information may be transmitted, without other patient-related information, as discussed above, in order to obtain a recommended immunization schedule from remote computer 830.

Communication network 820 may mobile voice telephone services and/or various data services. For discussion purposes, the diagram shows a wireless network 820. The network 820 may be operated by wireless service providers, carriers or operators. The communication network 820 implementing the illustrated system provides mobile voice telephone communications as well as other services such as text messaging and various multimedia packet data services, for numerous mobile devices. Today, mobile devices typically take the form of portable handsets, smart-phones, or personal digital assistants, data cards for computers, although they may be implemented in other form factors. The mobile communication network 820 provides communications between mobile device 810 and remote computer system 830, as well as communications with other mobile devices and servers not illustrated in FIG. 8. An inter-carrier or other intermediate network may provide communication connectivity between the mobile communication network 820 and remote computer system 830.

Mobile device 810 may also support downloading of executable programming, such as applications downloaded from an application store. An application programmed to perform the techniques described in this application may be among these applications. The application store may be hosted on an Internet site. In this example, the application store may communicate with the mobile device.

For digital wireless communications, the mobile device also includes at least one digital transceiver (not separately shown). The transceiver provides two-way wireless communication of information, such as vocoded speech samples and/or digital message information. The transceiver also sends and receives a variety of signaling messages in support of the various voice and data services provided via the mobile communication network 820. Each transceiver connects through RF send and receive amplifiers to an antenna. In the example, the transceiver is configured for RF communication in accord with a digital wireless protocol. The concepts discussed here encompass embodiments of mobile device 810 utilizing any digital transceivers that conform to current or future developed digital wireless communication standards, including cellular and wireless networking standards.

As shown by the above discussion, functions relating to the subject matter described above may be implemented on computers connected for data communication via the components of a network, operating as the various servers and/or client devices. Although special purpose devices may be used, remote server devices also may be implemented using one or more hardware platforms intended to represent a general class of data processing device commonly used to run “server” alone or in combination with “client” programming in the client devices, so as to implement the functions discussed above.

A server, such as remote computer system 830 for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers and client devices are conventional in nature, and it is presumed that those skilled in the art are adequately familiar therewith. Of course, the server functions may be implemented in a distributed fashion on a number of similar platforms, to distribute the processing load.

FIG. 1 illustrates a screen providing an interface 100 for listing and managing patients tracked by the application. List area 120 lists in alphabetical order patients 121 and 122 managed by the application. For each patient, a name 121a is displayed, and a number of outstanding immunizations 121b as displayed. Thus, in addition to the planner interface illustrated in FIGS. 4-7B, a user may readily view which patients are in need of immunizations.

FIG. 1 further illustrates mode selection area 130, which is also illustrated in a number of other figures, and provides a convenient interface element for switching among various modes of operation provided by the application. When the current mode of operation corresponds to one of the modes provided by mode selection area 130, a corresponding region of mode selection area 130 is highlighted to show that particular mode is active. Home button 131 advances the application to a start screen, from which a number of modes of operation, similar to those provided in mode selection area 130, may be selected. Patient management button 132 advances the application to the mode illustrated in FIG. 1, in which patients tracked by the application may be managed. Planner button 133 advances the application to the mode illustrated in FIGS. 4-7B. Mapping button 134 advances the application to the mode illustrated in FIG. 8, in which locations of regional medical providers providing immunization services may be shown on a map.

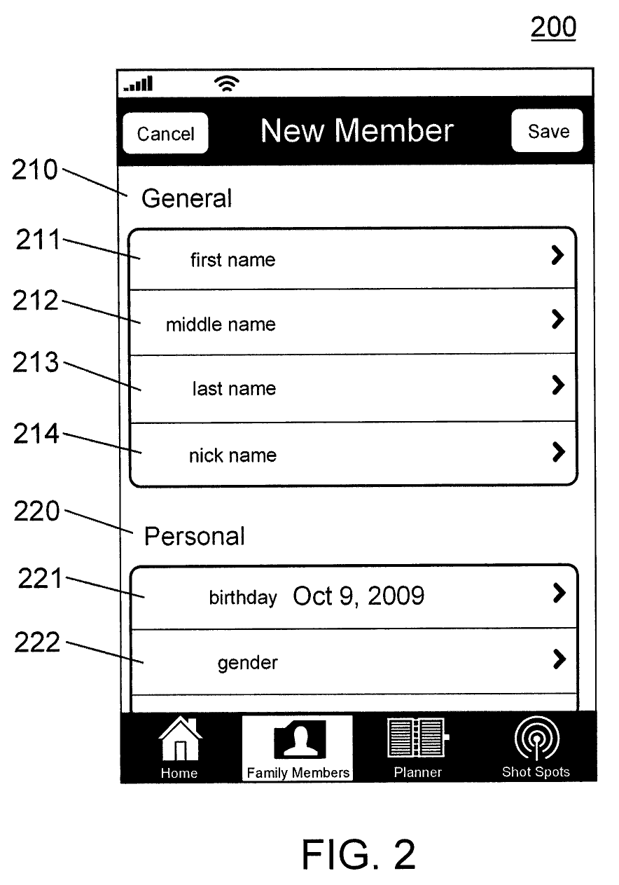

FIG. 2 illustrates a screen providing an interface 200 for the entry and review of patient information. Via interface 200, personal information particular to a patient may be listed, added, updated, or deleted. As illustrated in FIG. 2, a patient's information includes general information 210 such as the patient's first name 211, middle name or initial 212, last name 213, and a nick name 214. Nick name 214 is used when displaying the patient's name throughout the application, as illustrated by item 121 in FIG. 1. Where nick name 214 is not provided, first name 211 is used instead. The patient's information further includes personal information 220 such as the patient's birth date 221 and gender 222. Birth date 221 is required to generate immunization schedules, and the birth date 221 may be imported from a contacts database in the mobile device, if birth date information is included for the patient. Other patient information which may be entered, but is not shown in FIG. 2, is the patient's blood type, insurance information (such as insurer, policy number, and group number), and primary medical provider (such as a family physician or a clinic). For entering medical provider information, the user may import data from contacts managed by the mobile device in order to reuse contact information which has already been provided to the mobile device. For a medical provider not included in the contacts managed by the mobile device, information supplied to the application may be exported to the contacts managed by the mobile device. Once patient information is provided to the application, it is stored in nonvolatile memory for future use. In some embodiments, this information is not transmitted to an external server, in order to more clearly observe privacy regulations relating to medical information.

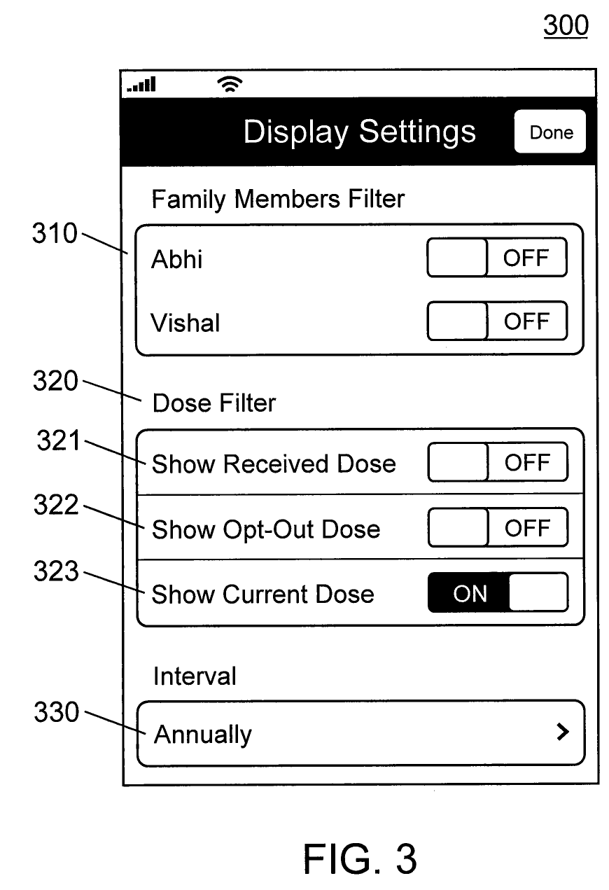

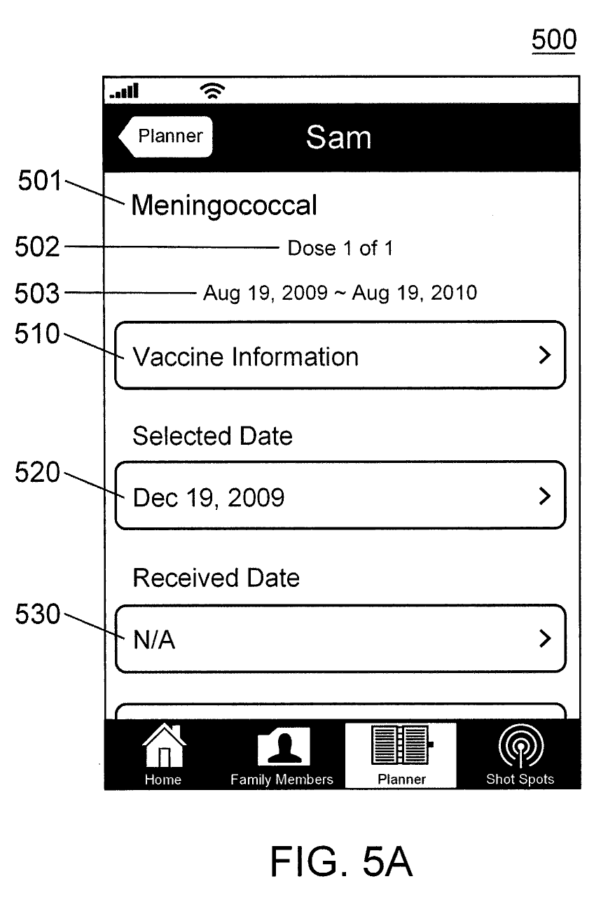

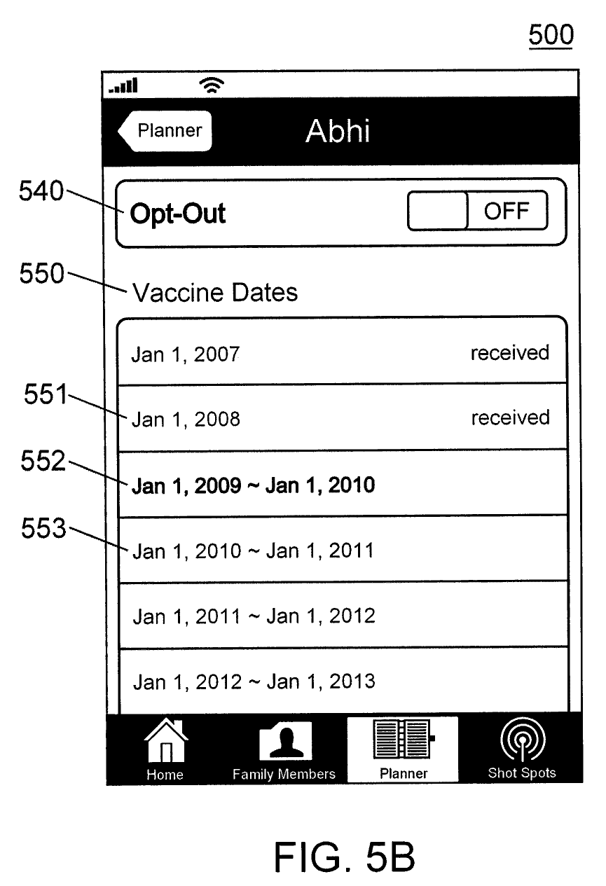

FIG. 3 illustrates a display settings screen 300 providing an interface for controlling information provided by the planner interface 400 illustrated in FIGS. 4-5B. This interface may be accessed via the start screen accessible via home button 131, or by setting button 401 provided on the planner interface (see FIG. 4). Primarily, the settings control the filtering of patient information provided to the user via the planner interface 400. Patient filter area 310 allows the user to select which of the patients managed by the application will be displayed in the planner interface 400. This may be used to reduce the volume of information that is displayed, or, for example, selectively displaying patients that share a common medical provider, in order to assist in minimizing the number of visits made to the medical provider in obtaining needed immunizations. Dose filter area 320 controls which types of inoculation doses are displayed on the planner interface 400. Received dose filter setting 321, when enabled, causes the planner interface 400 to display only immunizations which have already been received. This may be helpful where a user needs to review or provide a record of immunizations for a school, daycare, etc. being attended by a patient. Opt-out dose filter setting 322, when enabled, causes the planner interface 400 to display only immunizations which the user has chosen to opt out of (for example, via opt-out setting 540 illustrated in FIG. 5B). This facilitates identifying which immunizations a user has decided to opt out of. Accordingly, the user can track immunizations which may be rescheduled later, and be reminded of the alternate schedule. Current dose filter 323, when enabled, causes the planner interface to only display the next unreceived upcoming dose for each immunization. This facilitates review of upcoming immunizations by filtering out later doses. Interval setting 330 controls for which period of time recommended or scheduled immunizations are displayed in the planner interface 400. Particularly where there a plurality of patients being managed by the application, the user may only be interested in immunizations that are upcoming in the next quarter year, next half year, next full year, or some other period of time.

FIGS. 4A-4C illustrate operation of planner interface 400. Planner interface 400 includes settings button 401, which advances the application to display settings screen 300, discussed above with respect to FIG. 3. FIG. 4A illustrates an example where received dose filter setting 321 has been enabled, and only received immunizations are displayed in the planner interface 400. This provides an easy to read view of completed immunizations for discussion with a school or a medical provider, for example. A first listing section 410 is provided, under which is displayed received immunizations. The listing of received immunizations is grouped by patient 420. Under each patient 420 (although patients who have not received immunizations may be omitted, rather than presented with an empty listing), is a listing 430 of immunizations received by the patient. The listing comprises a number of received immunization entries 431. Immunization entries 431 provide a summary of each received immunization that includes identification of the immunization 431a, the date on which the immunization was received 431b, and, for immunizations in which a series of doses are made, a dose number 431c. As shown in FIG. 4A, patient “Ella” has received all 3 of 3 doses of immunization “Hepatitis B,” which the doses received on Jun. 11, 2002; Jul. 11, 2002; and Dec. 11, 2002. In the example illustrated in FIG. 4A, Ella has also received all 4 doses of the “Inactivated Poliovirus” immunization, but the list of received immunizations is too long to view at once on the screen. The remaining items in the list, and any listings for other patients, can be viewed by scrolling down in the view, an interface technique well known in the art. Additionally, by selecting one of immunization entries 431, the application will proceed to the immunization dose interface 500 illustrated in FIGS. 5A and 5B described below.

FIG. 4B illustrates an example of planning interface 400 in which upcoming immunizations are listed. A time period listing section 411 is provided, under which is displayed upcoming immunizations for patients managed by the application for a period of time—specifically in the next quarter year as illustrated in FIG. 4B. Much as discussed above with respect to received immunizations, within each listing section patients with upcoming immunizations within the period are displayed. Under each patient 440, is a listing of upcoming immunizations, the listing comprising a number of upcoming immunization entries 451. Upcoming immunization entries 451 provide a summary of each received immunization that includes identification of the immunization 451a, the date on which the immunization is (or should be) scheduled to be received 451b, and, for immunizations in which a series of doses are administered, a dose number 451c. FIG. 4C provides a similar illustration of planning interface 400 as discussed above with respect to FIG. 4B, but it illustrates two time period listing sections 411: one for immunizations in the upcoming quarter year, and another for immunizations in the following quarter year. By selecting one of upcoming immunization entries 451, the application will proceed to the immunization dose interface 500 illustrated in FIGS. 5A and 5B described below.

FIGS. 5A and 5B illustrate immunization dose interface 500, which enables review and entry of more detailed information about individual immunization doses than is presented in the immunization entries 431 and 451 shown in planning interface 400. Immunization dose interface 500 includes identification 501 of the immunization and the dose number 502 for a series of immunization doses. A recommended administration date range 503 is displayed. Vaccine information button 510 advances the application to immunization information interface 600 illustrated in FIGS. 6A and 6B and discussed below. Selected date selector 520 displays and allows the user to set a scheduled date for an upcoming immunization dose. The application may be configured to interact with a calendaring service provided by the mobile device, in order to provide calendaring and notification of upcoming immunization doses. Other notification services may be provided by the mobile device in order to alert the user of upcoming immunizations. Immunization tracking with reminders by telephone and letters has been shown to significantly improve the rate of immunization delivery. Tracy A. Lieu, et al., Effectiveness and Cost-effectiveness of Letters, Automated Telephone Messages, or Both for Underimmunized Children in a Health Maintenance Organization, Pediatrics, Vol. 101, No. 4, April 1998. Received date selector 530 displays and allows the user to set a date upon which an immunization dose was received. For convenience of updating this date upon administration of the dose, a date selection interface (not illustrated) defaults to the current date, although any date can be selected. Where there are subsequent doses for the immunization, the planned schedule for eth subsequent does is updated according to immunization schedule information employed by the application. A batch option may be provided to set the received date for multiple immunizations or does may be provided. FIG. 5B illustrates additional features of immunization dose interface 500. Opt-out setting 540 allows the user to opt-out of further administrations of doses of the immunization. For example, the user, in conjunction with the patient's medical provider, may agree that immunization, or further doses of the immunization, are to be delayed or deferred for the patient (one example is the estimated 1.6 percent of children with egg allergy preventing use of influenza vaccine). In that situation, opt-out setting 540 is set to “ON,” the dates are not calculated for the current dose or subsequent doses, if any, for the immunization. By not including unwanted immunizations, this simplifies review of upcoming immunizations via planning interface 400. Dose date display section 550 displays received dose dates 551, a selected date or recommended date range for the next dose 552, and recommended date ranges for subsequent doses 553. Once the information discussed with respect to FIGS. 5A and 5B is provided to the application, it is stored in nonvolatile memory for future use. In some embodiments, this information is not transmitted to an external server, in order to more clearly observe privacy regulations relating to medical information.

FIG. 6A illustrates immunization information interface 600, accessible via information button 510, as described above, or possibly available via another mechanism, such as a general listing of immunizations, via the home screen discussed above. In information display area 601, descriptive information is provided regarding a given immunization or the disease it is designed to prevent. The intended audience of this information is an end user or immunization recipient, rather than a medical professional (although some embodiments may be more particularly directed for the use of medical professionals). Accordingly, the displayed information is directed toward giving non-medical professionals a better understanding of the benefits and usefulness of various immunizations. Accordingly, beyond the scheduling the recordkeeping functions served by embodiments of this invention, some embodiments also serve an education function that seeks to further encourage participation in immunization programs. FIG. 6B illustrates another immunization information interface 650, in which videos 651 are provided to provide information about immunizations or the diseases which they are designed to prevent. In other embodiments, links may be provided to web sites containing immunization information, where said links cause a web browser application or component in the mobile device to display information from the linked web site.

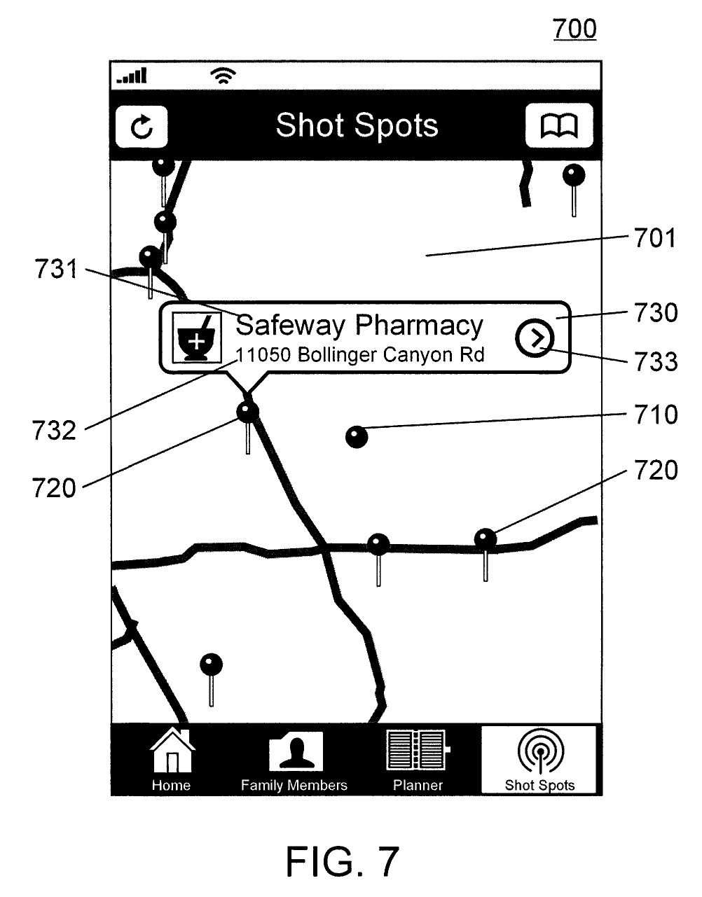

FIG. 7 illustrates an interface 700 for finding and displaying regional immunization providers. The user's region may be determined by GPS or other location-aware features available to the mobile device, a ZIP code entered into the application, an address imported from a contact managed by the mobile device, or other mechanisms for selecting a location. Based on a supplied location, the application identifies immunization providers in a region surrounding the location. Immunization provider location information is provided by remote computer system 830, which allows for continuous updates of locations to be made available. As illustrated in FIG. 7, a map 701 may be displayed, with selected location 710 displayed, an regional immunization providers 720 also displayed. Where an individual immunization provider is selected via interface 700, summary information 730, including the provider's name 731 and location 732 are displayed. More detailed information is available via details button 733. Such details typically include a telephone number for the immunization provider, to facilitate contacting and scheduling an appointment with the immunization provider. Much of the above mapping-related activities may be performed by programmatic interfaces supplied as part of the operating system of the mobile device. Other embodiments may employ a simpler text-based interface for listing regional providers.

Various embodiments of the disclosed subject matter may be implemented using electronic circuitry configured to perform one or more of the functions described herein. For example, with some embodiments, functions may be implemented using one or more application-specific integrated circuits (ASICs). More typically, however, components of various embodiments will be implemented using a programmable computing device executing firmware of software instructions, or by some combination of purpose-specific electronic circuitry and firmware or software instructions executing on a programmable computer.

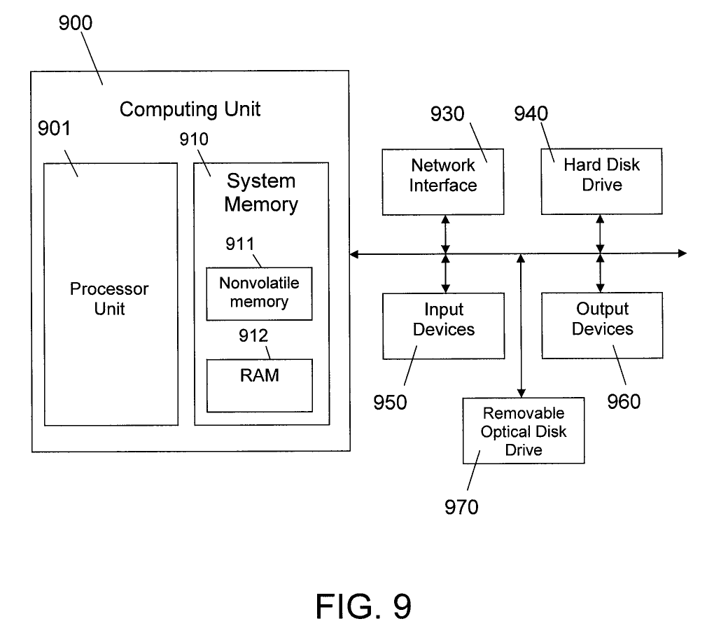

FIG. 9 illustrates a programmable computer system for some embodiments of the disclosed subject matter. A processor unit 901 serves as a programmable controller for the computing unit 900, in that it controls operations of the computing unit 900 in accord with programming that it executes, for all normal operations, and for operations involved in the methods described herein. In the example shown in FIG. 9, the computing unit 900 includes non-volatile memory, for example, flash type program memory 911, for storage of various “software” or “firmware” program routines, configuration settings, and other data. The computing unit 900 may also include a non-volatile random access memory (RAM) 912 for a working data processing memory. The computing device 900 may also include a removable memory, for example, a UICC smartcard (not shown). Of course, other storage devices or configurations may be added to or substituted for those in the example. In a present implementation, the flash type memory 911 stores firmware such as a boot routine, device driver software, an operating system, call processing software and vocoder control software, and any of a wide variety of other applications, such as client browser software and short message service software. The memories 911 and 912 also store various data, such as telephone numbers and server addresses, downloaded data such as multimedia content, and various data input by the user. Programming stored in the flash type program memory 911, sometimes referred to as “firmware,” is supplied to and executed by the processor unit 901.

As known in the data processing and communications arts, a general-purpose computer typically comprises a central processor or other processing device, an internal communication bus, various types of memory or storage media (RAM, ROM, flash memory, cache memory, disk drives, etc.) for code and data storage, and one or more network interface cards or ports for communication purposes. The software functionalities involve programming, including executable code as well as associated stored data, e.g. files used for the various polices, tables and managed information content. The software code is executable by the general-purpose computer that functions as the server and/or that functions as a client device. In operation, the code is stored within the general-purpose computer platform. At other times, however, the software may be stored at other locations and/or transported for loading into the appropriate general-purpose computer system. Execution of such code by a processor or central proceeding unit of the computer platform enables the platform to implement the disclosed techniques, in essentially the manner performed in the embodiments discussed and illustrated herein.

The computing unit 900 may be connected to a network interface 930 (e.g., Ethernet or wireless communications), a hard disk drive 940, input devices 950 (e.g., touch screen or keyboard), output devices 960 (e.g., a display screen or printer), and a removable optical disk drive 970 (e.g., compact disc or DVD, read-only or recordable).

The computing unit 900 may be connected to or otherwise include one or more peripheral devices, such as a telephone. The telephone may be, for example, a wireless “smart phone.” As known in the art, this type of telephone communicates through a wireless network using radio frequency transmissions. In addition to simple communication functionality, a “smart phone” may also provide a user with one or more data management functions, such as sending, receiving, and viewing electronic messages (e.g., electronic mail messages, SMS text messages, etc.), recording or playing back images files, viewing and editing files with text (e.g., word processing, spreadsheet, or PDF files), etc. Because of the data management capability of this type of telephone, a user may connect the telephone to a personal computer so that data may be synchronized between the two.

Hence, aspects of the methods outlined above may be embodied in programming. Program aspects of the technology may be thought of as “products” or “articles of manufacture” typically in the form of executable code and/or associated data that is carried on or embodied in a type of machine readable medium. “Storage” type media include any or all of the memory of the computers, processors or the like, or associated modules thereof, such as various semiconductor memories, tape drives, disk drives and the like, which may provide storage at any time for the software programming. All or portions of the software may at times be communicated through the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the methods described in this application. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

In some embodiments, the disclosed techniques may also be practiced with a web browser, with many of he disclosed techniques being performed by a web server or other remote computing devices. However, where patient data is being provided to the web server, this presents challenges for maintaining the confidentiality of patent data.

Although immunizations for humans are illustrated in this disclosure, the invention may also be practiced with respect to veterinary immunizations, whether for pets or livestock. For example, household pets such as dogs also receive a series of immunizations over their lifetimes, including immunizations specific to juvenile animals, and subsequent periodic administration of vaccines such as for rabies.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A computer-implemented method for patient management of immunizations, comprising steps of:
recording first patient information for a first patient, the first patient information including a date of birth;
recording information for immunization doses received in the past by the first patient, the information including the date each immunization dose was received;
obtaining an immunization schedule via a data network from a remote computer system;
generating a plurality of recommended immunization doses for the first patient based on the recorded immunization doses received in the past by the first patient and the recorded date of birth of the first patient, each recommended immunization dose having a recommended time period for administration of the dose;
recording a selected date of administration for a recommended immunization dose for the first patient;
displaying a list of the recommended immunization doses for the first patient, along with their respective date of administration or recommended time period for administration,
wherein the above steps are performed by one or more computers programmed to perform the above steps.

2. The computer-implemented method of claim 1, further comprising steps of:
recording second patient information for a second patient, the second patient information including a date of birth;
recording information for immunization doses received in the past by the second patient, the information including the date each immunization dose was received;
generating a plurality of recommended immunization doses for the second patient based on the recorded immunization doses received in the past by the second patient and the recorded date of birth of the second patient, each recommended immunization dose having a recommended time period for administration of the dose;
recording a selected date of administration for a recommended immunization dose for the second patient, wherein
the step of displaying further lists the recommended immunization doses for the first patient, along with their respective date of administration or recommended time period for administration.

3. The computer-implemented method of claim 1, wherein
in the step of displaying, only recommended immunization doses with a respective date of administration or recommended time period for administration within a selected time period are displayed.

4. The computer-implemented method of claim 1, further comprising
recording a selection for the first patient to opt out of further doses of a first immunization, wherein
in the step of displaying, the list excludes recommended immunization doses for the first patient, where the doses are for the first immunization.

5. The computer-implemented method of claim 1, wherein
the recording step includes recording the selected date in an electronic calendar.

6. The computer-implemented method of claim 1, further comprising the steps of:
obtaining a geographic location;
identifying a plurality of medical providers that administer a first immunization with physical proximity to the geographic location;
displaying location information for the plurality of medical providers.

7. A system for patient management of immunizations, comprising a mobile computing device programmed to perform the steps of:
recording, in a non-volatile memory included in the mobile computing device, first patient information for a first patient, the first patient information including a date of birth;
recording, in the non-volatile memory, information for immunization doses received in the past by the first patient, the information including the date each immunization dose was received;
obtaining an immunization schedule via a data network from a remote computer system;
generating a plurality of recommended immunization doses for the first patient based on the recorded immunization doses received in the past by the first patient and the recorded date of birth of the first patient, each recommended immunization dose having a recommended time period for administration of the dose;
recording, in the non-volatile memory, a selected date of administration for a recommended immunization dose for the first patient;
displaying a list of the recommended immunization doses for the first patient, along with their respective date of administration or recommended time period for administration.

8. The system of claim 7, wherein
none of the first patient information, the information for immunization doses received in the past by the first patient, or the selected date of administration for a recommended immunization dose for the first patient are sent via the data network.

9. The system of claim 7, where the mobile computing device is further programmed to perform the steps of:
recording second patient information for a second patient, the second patient information including a date of birth;
recording information for immunization doses received in the past by the second patient, the information including the date each immunization dose was received;
generating a plurality of recommended immunization doses for the second patient based on the recorded immunization doses received in the past by the second patient and the recorded date of birth of the second patient, each recommended immunization dose having a recommended time period for administration of the dose;
recording a selected date of administration for a recommended immunization dose for the second patient, wherein
the step of displaying further lists the recommended immunization doses for the first patient, along with their respective date of administration or recommended time period for administration.

10. An article of manufacture, comprising programming instructions for causing a processor to perform the method of claim 1 and a machine readable storage medium bearing the programming instructions.
